(19) United States
(12) Patent Application Publication
(10) Pub. No.: US 2008/0107205 A1
(43) Pub. Date: May 8, 2008

(54) Apparatus for transmitting and receiving wireless data and method of transmitting and receiving wireless data

(75) Inventors: Chang-yeul Kwon, Yongin-si (KR); Seong-Soo Kim, Seoul (KR); Joong-suk Park, Seongnam-si (KR); Ji-sung Oh, Seongnam-si (KR); Hee-Yong Park, Suwon-si (KR); Se-young Shin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/649,847

(22) Filed: Jan. 5, 2007

Related U.S. Application Data
(60) Provisional application No. 60/756,222, filed on Jan. 5, 2006.

(30) Foreign Application Priority Data
Apr. 11, 2006 (KR) 10-2006-0032887

(51) Int. Cl. H04L 27/00

(52) U.S. Cl. 375/316

(57) ABSTRACT

An apparatus and method are provided for transmitting and receiving wireless data and a method of transmitting and receiving wireless data in which a frame is transmitted via one of a plurality of channels, a response frame is received via another of the channels in return for the frame, the receive sensitivity for the frame is determined based on the response frame, and a set of TXVECTOR parameters are controlled according to the determination. The apparatus includes a media access control (MAC) unit which generates a data frame, a first physical (PHY) unit which transmits a wireless signal of the data frame via a first channel, a second PHY unit which receives a control frame comprising a receive sensitivity for the wireless signal via a second channel, and a parameter control unit which adjusts a set of TXVECTOR parameters for the data frame via the first channel based on the control frame.

### CROSS-REFERENCE TO RELATED APPLICATION

This application claims priority from Korean Patent Application No. 10-2006-0032887 filed on Apr. 11, 2006 in the Korean Intellectual Property Office, and U.S. Provisional Patent Application No. 60/756,222 filed on Jan. 5, 2006 in the United States Patent and Trademark Office, the disclosures of which are incorporated herein by reference in their entirety.

### BACKGROUND OF THE INVENTION

1. Field of the Invention

Apparatuses and methods consistent with the present invention relate to transmitting and receiving wireless data, and more particularly, to transmitting and receiving wireless data wherein a predetermined frame is transmitted via one of a plurality of channels, a response frame is received via another of the channels in return for the predetermined frame, the receive sensitivity for the predetermined frame is determined based on the response frame, and a set of TXVECTOR parameters are controlled according to the result of the determination.

2. Description of the Related Art

As wireless networks become widespread and the frequency of transmission of vast amounts of multimedia data increases, the demand for efficient data transmission method suitable for wireless network environments has steadily grown. Due to the properties of wireless networks in which a plurality of devices are supposed to share given wireless resources, the more contention for wireless resources there is, the more data collisions occur, and the more likely the wireless resources are to be wasted.

In order to reduce data collisions or wireless resource loss, a distributed coordination function (DCF), which is a contention-based protocol, and a point coordination function (PCF), which is a contention-free protocol, have been widely used in wireless local area network (LAN) environments, and a channel time allocation method has been widely used in wireless personal area network (PAN) environments.

The aforementioned method can reduce data collisions in a wireless network to some extent and thus enable stable communication between devices in the wireless network. However, the probability of a plurality of transmitted data colliding with one another is still higher in a wireless network than in a wired network because a number of factors that interfere with stable communication such as multi-path, fading, and interference effects exist in a wireless network environment. In addition, the more wireless devices that participate in a wireless network, the more likely data collisions or data loss is to occur.

Data collisions require data retransmissions that adversely affect the throughput of wireless networks. In particular, for such data that requires a high quality of service (QoS) as audio/video (A/V) data, it is very important to secure as wide an available bandwidth as possible by reducing the number of retransmissions.

Further, there is a method of effectively using wireless channels by adjusting a set of TXVECTOR parameters such as LENGTH, DATARATE, and TXPWR_LEVEL according to the state of each wireless channel. In this method, a transmitting station receives a frame from a receiving station, determines the state of a channel based on the receive sensitivity for the received frame or based on statistical information regarding frames that have been transmitted to the receiving station, and transmits a data frame to the receiving station according to the result of the determination. Here, the receive sensitivity for the received frame may be a received signal strength indicator (RSSI) or signal-to-noise ratio (SNR).

In this method, however, there is a high probability of wireless channels being wasted during the transmission of a data frame by a transmitting station and during the transmission of an acknowledgement frame by a receiving station in return for the data frame. In other words, a transmitting station cannot transmit any data frame during the transmission of an acknowledgement frame by a receiving station. Therefore, it is necessary to develop a method capable of transmitting/receiving a data frame and an acknowledgement frame at the same time.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for transmitting and receiving wireless data in which a predetermined frame is transmitted via one of a plurality of channels, a response frame is received via another of the channels in return for the predetermined frame, the receive sensitivity for the predetermined frame is determined based on the response frame, and a set of TXVECTOR parameters are controlled according to the result of the determination.

According to an aspect of the present invention there is provided an apparatus for transmitting wireless data, the apparatus including a media access control (MAC) unit which generates a data frame, a first physical (PHY) unit which transmits a wireless signal of the data frame via a first channel, a second PHY unit which receives a control frame comprising a receive sensitivity for the wireless signal via a second channel, and a parameter control unit which adjusts a set of TXVECTOR parameters for the data frame via the first channel based on the control frame.

According to another aspect of the present invention, there is provided an apparatus for receiving wireless data, the apparatus including a first PHY unit which receives a data frame via a first channel and determines a receive sensitivity of the first channel based on the data frame, a MAC unit which generates a control frame comprising the receive sensitivity, and a second PHY unit which transmits the control frame via a second channel.

According to another aspect of the present invention, there is provided a method of transmitting wireless data, the method including generating a data frame, transmitting a wireless signal of the data frame via a first channel, receiving a control frame comprising a receive sensitivity for the wireless signal via a second channel, and adjusting a set of TXVECTOR parameters for the data frame via the first channel based on the control frame.

According to another aspect of the present invention, there is provided a method of receiving wireless data, the method including receiving a data frame via a first channel and determines a receive sensitivity of the first channel based on the data frame, generating a control frame comprising the receive sensitivity, and transmitting the control frame via a second channel.

### BRIEF DESCRIPTION OF THE DRAWINGS

The above and other aspects of the present invention will become more apparent by describing in detail exemplary embodiments thereof with reference to the attached drawings, in which:

FIG. 1 is a diagram for explaining the transmission and reception of frames via multiple channels according to an exemplary embodiment of the present invention;

FIG. 2 is a diagram illustrating a communication layer according to an exemplary embodiment of the present invention;

FIG. 3 is a block diagram of an apparatus for transmitting wireless data according to an exemplary embodiment of the present invention;

FIG. 4 is a block diagram of an apparatus for receiving wireless data according to an exemplary embodiment of the present invention;

FIG. 5 is a flowchart illustrating a method of transmitting wireless data according to an exemplary embodiment of the present invention; and

FIG. 6 is a flowchart illustrating a method of receiving wireless data according to an exemplary embodiment of the present invention.

### DETAILED DESCRIPTION OF THE EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. Like reference numerals in the drawings denote like elements, and thus redundant descriptions will be omitted.

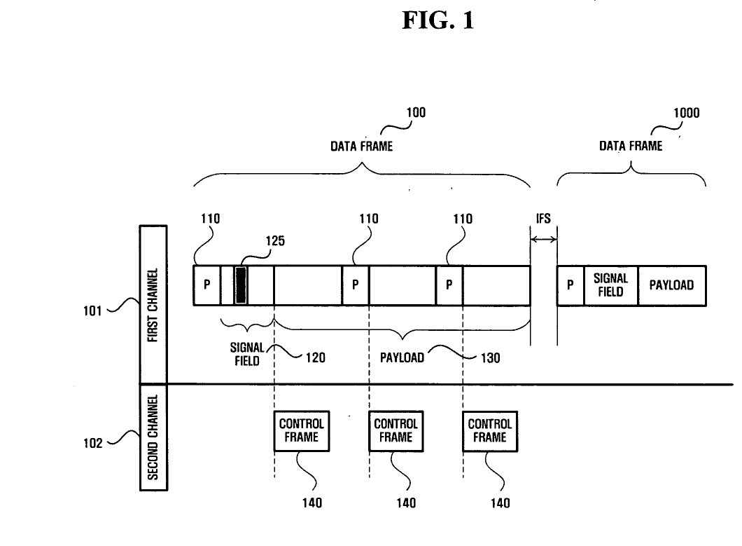

FIG. 1 is a diagram for explaining the transmission and reception of frames via multiple channels according to an exemplary embodiment of the present invention. Referring to FIG. 1, a wireless signal of a data frame 100 is transmitted via one of a plurality of communication channels, i.e., a first channel 101. A plurality of control frames 140 are transmitted via another of the communication channels, i.e., a second communication channel 102. The control frames 140 include the receive sensitivity for the wireless signal of the data frame 100.

An apparatus for transmitting wireless data (hereinafter referred to as the transmitting station) may transmit a plurality of data frames to an apparatus for receiving wireless data (hereinafter referred to as the receiving station) via the first channel 101. An interframe space (IFS) exists among a pair of adjacent data frames, e.g., the data frame 100 and a data frame 1000. The IFS may be an extended IFS, a distributed IFS, a point IFS, or a short IFS.

Referring to FIG. 1, the data frame 100 includes a preamble 110, a signal field 120, and a payload 130. The preamble 110 comprises a plurality of signals for PHY layer synchronization and channel estimation. In detail, the preamble 110 comprises a plurality of short training signals and a plurality of long training signals. The short training signals are used for signal detection, auto gain control (AGC), minute time synchronization and coarse frequency offset estimation purposes, and the long training signal are used for channel estimation and fine frequency offset estimation. In general, the speed and precision of estimation may considerably affect the performance of an entire communication system.

The signal field 120 comprises a rate field which indicates transmission rate, and a length field which indicates the length of a PHY protocol data unit (PPDU). In general, the signal field 120 is encoded into a single symbol.

The preamble 110 and the signal field 120 constitute a PHY header. The payload 130 follows the PHY header. The payload 130 may comprise two or more preambles 110 which are a predetermined distance apart from each other.

The receiving station receives the data frame 100 via the first channel, and transmits a control frame 140 containing a receive sensitivity for the data frame 100 via the second channel 102. The control frames 140 may be in return for the respective preambles 110 of the data frame 100. In other words, the receiving station determines the intensities of the preambles 110 of the data frame 100, and transmits a plurality of control frames 140, each control frame 140 containing a receive sensitivity for the corresponding preamble 110.

The signal field 120 may also include a flag (hereinafter referred to as the receive sensitivity determination request flag) 125 that is needed to enable the receiving station to determine the receive sensitivity for a preamble 110 of the data frame 100. Accordingly, the receiving station may transmit either a control frame 140 containing a receive sensitivity for the data frame 100 or a control frame 140 simply containing acknowledgement information according to whether the data frame 100 includes the receive sensitivity determination request flag 125.

The transmitting station receives the control frames 140 transmitted by the receiving station, adjusts a set of TXVECTOR parameters, which are parameters regarding the transmission of data frames, and transmits the data frame 1000 according to the results of the adjustment. The TXVECTOR parameters include LENGTH, DATARATE, and TXPWR_LEVEL.

In detail, the TXVECTOR parameter LEGNTH indicates the number of octets of data to be transmitted via the PHY layer by a media access control (MAC) unit, and has a value of 1-4095. The TXVECTOR parameter DATARATE indicates the transmission rate of signals to be transmitted in a wireless local area network (LAN), and has a value supported by the Institute of Electrical and Electronics Engineers (IEEE) 802.11a standard. The TXVECTOR parameter TXPWR_LEVEL is used to determine the power of a current transmission signal, and has a value of 1-8.

The transmitting station may adjust the TXVECTOR parameters by averaging the receive sensitivities respectively included in the control frames 140 or by applying a greater weight to the receive sensitivity included in the control frame 140 most recently received.

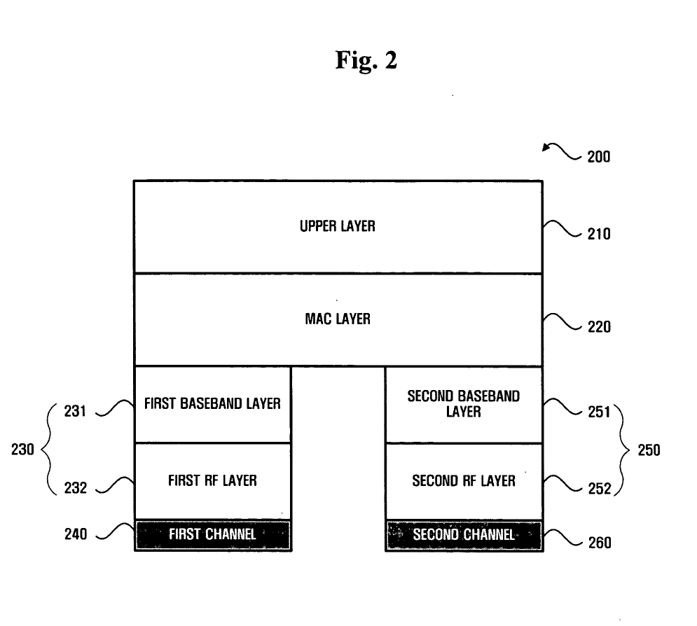

FIG. 2 is a diagram illustrating a communication layer 200 according to an exemplary embodiment of the present invention. Referring to FIG. 2, the communication layer 200 includes channel layers 240 and 260 which are lowermost physical media corresponding to a predetermined frequency band through which wireless signals are transmitted, radio frequency (RF) layers 232 and 232, baseband layers 231 and 251, a MAC layer 220, and an upper layer 210. The upper layer 210 is located above the MAC layer 220, and may include a logical link control layer, a network layer, a transmission layer, and an application layer.

According to the present exemplary embodiment, a plurality of wireless channels, e.g., the first channel 101 and the second channel 102, are provided. The first and second channels 101 and 102 may correspond to different frequency bands and adopt different modulation methods. Accordingly, two PHY layers 230 and 250 are respectively provided for the first and second channels 101 and 102. The upper layer 210 may be comprised of a single layer.

The first channel 101 corresponds to a frequency band of 60 GHz, and the second channel 102 corresponds to a frequency band of 2.4 or 5 GHz. The first channel 101 may be a unidirectional channel having a directivity, and the second channel 102 may be a bidirectional channel having no directivity.

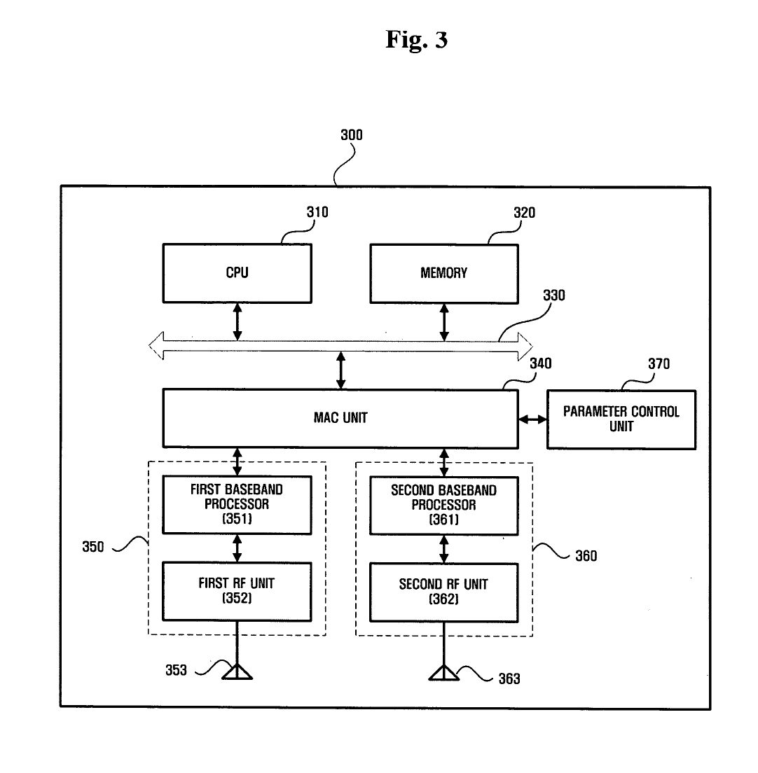

FIG. 3 is a block diagram of an apparatus 300 (hereinafter referred to as the transmitting station 300) for transmitting wireless data according to an exemplary embodiment of the present invention. Referring to FIG. 3, the transmitting station 300 includes a central processing unit (CPU) 310, a memory 320, an MAC unit 340, a first PHY unit 350, a second PHY unit 360, and a parameter control unit 370.

The CPU 310 controls elements of the transmitting station 300 that are connected to a bus 330. The CPU 310 handles performed in the upper layer 210 illustrated in FIG. 2. Accordingly, the CPU 310 processes a received MAC service data unit (MSDU) provided by the MAC unit 340, or generates a MSDU to be transmitted and provides the MAC unit 340 with the MSDU to be transmitted.

The memory 320 stores data. The memory 320 is a module to/from which data can be input/output such as a hard disc, an optical disc, a flash memory, a compact flash (CF) card, a secure digital (SD) card, a smart media (SM) card, a multimedia card (MMC), or a memory stick. The memory 320 may be included in the transmitting station 300 or in an external apparatus.

The MAC unit 340 generates a MAC protocol data unit (MPDU) by attaching a MAC header to an MSDU provided by the CPU 310, i.e., to data to be transmitted.

Also, the MAC unit 340 determines the type of frame, and controls a communication path so that the corresponding frame can be transmitted/received via the first and second PHY units 350 and 360. For example, the MAC unit 340 controls data stored in the memory 320 to be transmitted through the first PHY unit 350 and controls other frames for acknowledgement to be transmitted/received through the second PHY unit 360.

The first PHY unit 350 converts an MPDU generated by the MAC unit 340 into a wireless signal, and transmits the wireless signal via the first channel 101. For this, the first PHY unit 350 includes a first baseband processor 351 and a first RF unit 352, and is connected to a first antenna 353. Wireless signals transmitted/received via the first antenna 353 have higher frequencies than wireless signals transmitted/received via a second antenna 363, and have a directivity.

The first baseband processor 351 is provided with an MPDU generated by the MAC unit 340, and generates a PPDU by adding a signal field 120 and a preamble 110 to the MPDU. Then, the first RF unit 352 converts the PPDU generated by the first baseband processor 351 into a wireless signal, and transmits the wireless signal via the first antenna 353.

According to the present exemplary embodiment, the first baseband processor 351 may insert two or more preambles 110 into a PPDU so that the preambles 110 are a predetermined distance apart from each other. In this case, a receiving station can determine the receive sensitivity for each of the preambles 110 inserted into the PPDU inserted into the PPDU by the first baseband processor 351.

A receive sensitivity determination request flag 125 may be inserted into the signal field 120. The receiving station may decide whether to determine the receive sensitivity for the preambles 110 according to whether the signal field 120 comprises the receive sensitivity determination request flag 125.

The receiving station determines the receive sensitivity for the preambles 110, and transmits a control frame 140 containing the result of the determination, i.e., the receive sensitivity of the first channel 101 for a wireless signal, to the transmitting station 300. Then, the second PHY unit 360 receives the control frame 140 via the second channel 102. The receive sensitivity included in the control frame 140 may be a RSSI, SNR, BER, packet error rate (PER), signal-to-interference ratio (SIR), or carrier-to-interference ratio (CIR).

The second PHY unit 360 may receive a control frame 140 for each of the preambles 110 inserted into the PPDU by the first baseband processor 351.

The parameter control unit 370 adjusts a set of TXVECTOR parameters for data frames that are transmitted via the first channel 101 based on a control frame 140 received by the transmitting station 300. The TXVECTOR parameters include LENGTH, DATARATE, and TXPWR_LEVEL.

Then, the first PHY unit 350 generates a data frame 1000, i.e., a wireless signal of an MPDU, according to the results of the adjustment performed by the parameter control unit 370, and transmits the wireless signal of the MPDU via the first channel 101.

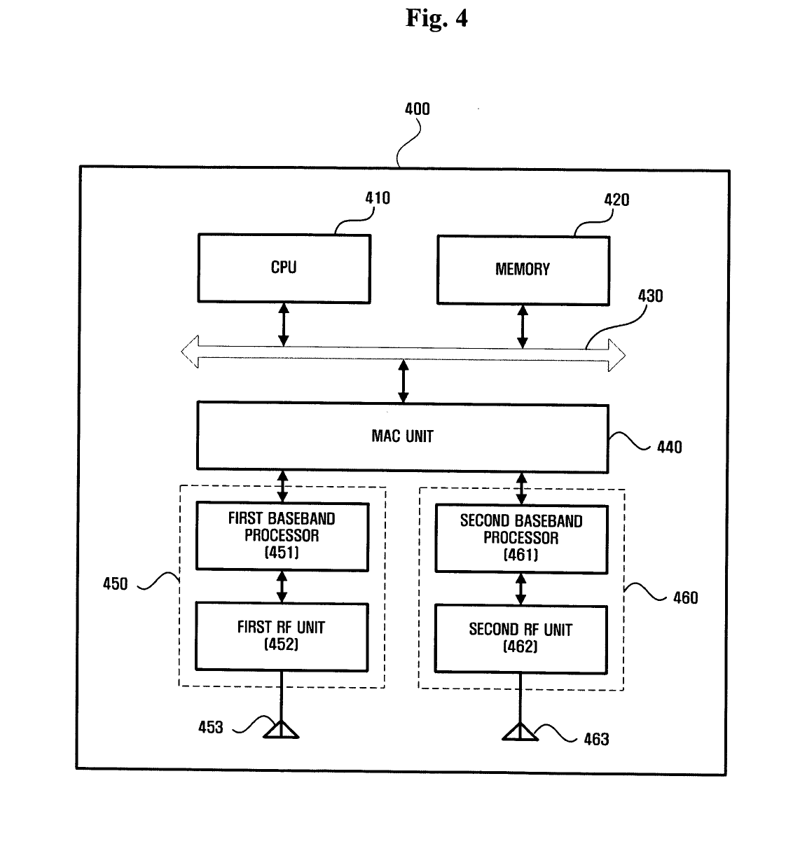

FIG. 4 is a block diagram of an apparatus 400 (hereinafter referred to as the receiving station 400) for receiving wireless data according to an exemplary embodiment of the present invention. Referring to FIG. 4, the receiving station 400 has the same structure as the transmitting station 300 illustrated in FIG. 3 except that the receiving station 400 does not include a parameter control unit. Thus, the receiving station 400, unlike the transmitting station 300, transmits frames without the need to control a set of TXVECTOR parameters for the frames. However, the receiving station 400 may serve the same functions as the transmitting station 300. In this case, the TXVECTOR parameters may be controlled by a parameter control unit (not shown) of the receiving station 400.

When a wireless signal of a data frame 100 having a directivity is received from the transmitting station 300 via an array antenna, i.e., a first antenna 453, the receiving station 400 optimizes the first antenna 453 and thus establishes the direction of the received wireless signal, thereby maximizing the reception performance of the receiving station 400.

For this, a first RF unit 452 receives a plurality of wireless signals having different phases via the first antenna 453, and performs a DCF on the sum of the received wireless signals, thereby determining a direction of arrival (DOA) of the received wireless signals. Thereafter, the first RF unit 452 establishes the direction of the received wireless signals by combining the amplitudes and phases of the received wireless signals.

A wireless signal received by the receiving station 400 is restored as a data frame, i.e., a PPDU, by the first RF unit 452, and the PPDU is transmitted to a first baseband processor 451. Then, the first baseband processor 451 may determine the receive sensitivity for the received wireless signal based on two or more preambles 110 that are inserted into the PPDU and are a predetermined distance apart from each other.

The first baseband processor 451 may determine the receive sensitivity for the received wireless signal only when a signal field 120 of the PPDU comprises a receive sensitivity determination request flag 125. The receive sensitivity for the received wireless signal may be an RSSI, SNR, BER, PER, SIR, or CIR.

The first baseband processor 451 removes a PHY header (i.e., the preambles 110 and the signal field 120) from the PPDU, thereby generating an MPDU. Then, the first baseband processor 451 provides the MPDU to an MAC unit 440 together with the receive sensitivity for the received wireless signal. In addition, the MAC unit 440 removes a MAC header from the MPDU, thereby generating an MSDU. Then, the MAC unit 440 provides the MSDU to the CPU 410. The CPU 410 performs a predetermined operation regarding data included in the MSDU.

The MAC unit 440 generates a control frame 140 that comprises the receive sensitivity for the received wireless signal, and a second PHY unit 460 transmits the control frame 140 generated by the MAC unit 440 via the second channel 102. The MAC unit 440 may receive two or more receive sensitivities for respective corresponding wireless signals, and generate a control frame 140 for each of the received receive sensitivities.

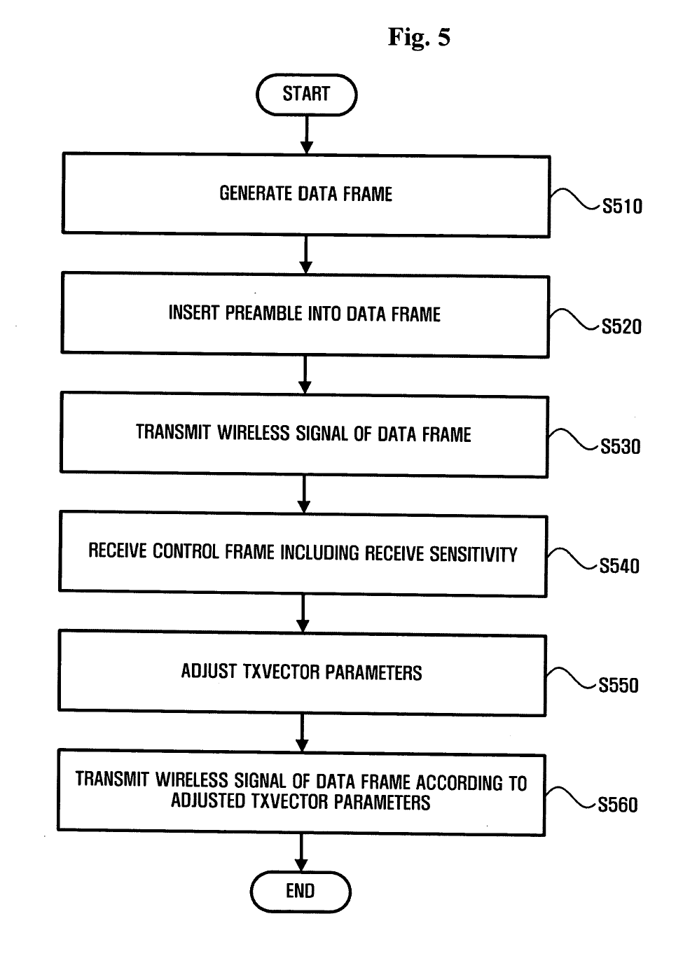

FIG. 5 is a flowchart illustrating a method of transmitting wireless data according to an exemplary embodiment of the present invention. Referring to FIG. 5, in operation S510, the MAC unit 340 of the transmitting station 300 generates a data frame 100. In other words, the MAC unit 340 generates an MPDU by adding a MAD header to an MSDU provided by the CPU 310.

In operation S520, the MPDU is transmitted to the first PHY unit 350, and the first baseband processor 351 of the first PHY unit 350 adds a signal field 120 and a preamble 110 to the MPDU, thereby generating a PPDU. According to the present exemplary embodiment, the first baseband processor 351 may insert two or more preambles 110 into the PPDU so that the preambles 110 are a predetermined distance apart from each other.

In operation S530, the PPDU is transmitted to the first RF unit 352, the first RF unit 352 converts the PPDU into a wireless signal, and transmits the wireless signal to the receiving station 400 via the first antenna 353.

The receiving station 400 determines the receive sensitivity for each of the preambles 110, and transmits a control frame 140 including the result of the determination, i.e., the receive sensitivity of the first channel 101 for a wireless signal, to the transmitting station 300. Then, in operation S540, the second PHY unit 360 receives the control frame 140 via the second channel 102. The receive sensitivity included in the control frame 140 may be an RSSI, SNR, BER, PER, SIR, or CIR.

According to the present exemplary embodiment, in operation S540, the second PHY unit 360 may receive a control frame 140 for each of the preambles 110 that are inserted into the PPDU by the first baseband processor 351.

In operation S550, the control frame 140 is transmitted to the parameter control unit 370, and the parameter control unit 370 adjusts a set of TXVECTOR parameters for data frames transmitted via the first channel 101 based on the control frame 140. The TXVECTOR parameters may include LENGTH, DATARATE, and TXPWR_LEVEL.

In operation S560, the transmitting station 300 transmits wireless signals of data frames later on according to the results of the adjustment performed in operation S550.

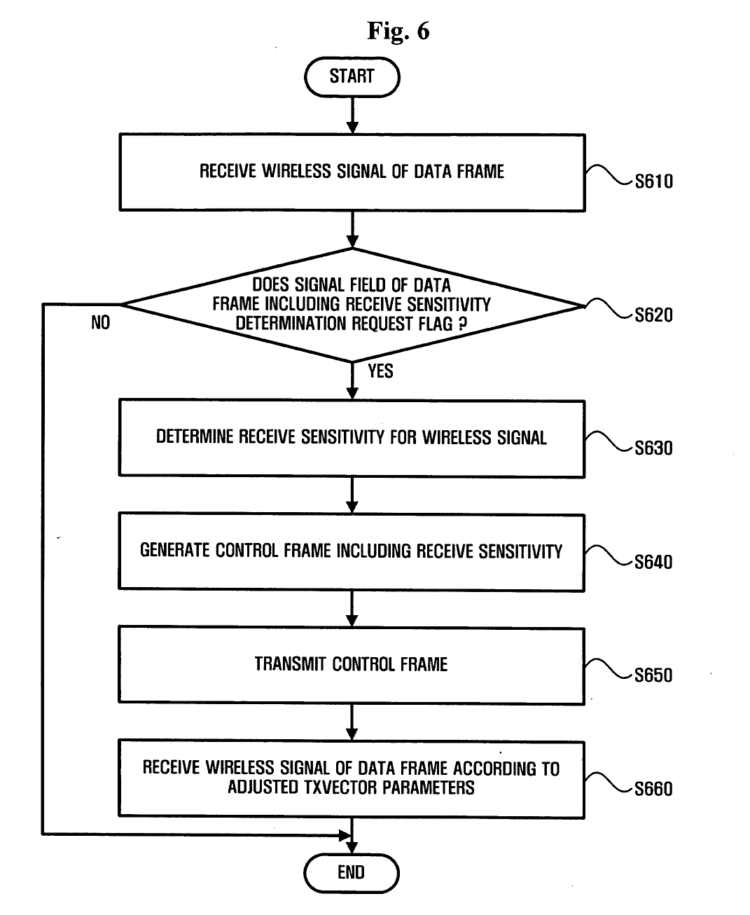

FIG. 6 is a flowchart illustrating a method of receiving wireless data according to an exemplary embodiment of the present invention. Referring to FIG. 6, in operation S610, the first PHY unit 450 of the receiving station 400 receives a wireless signal of a data frame 100 from the transmitting station 300 via a data transmission channel (i.e., the first channel 101) in order to provide the transmitting station 300 with information indicating the receive sensitivity of the first channel 101.

In operation S620, the first baseband processor 451 of the first PHY unit 450 determines whether a signal field 120 of the data frame 100 comprises a receive sensitivity determination request flag 125.

In operation S630, if it is determined in operation S620 that the signal field 120 of the data frame 100 comprises the receive sensitivity determination request flag 125, then the receive sensitivity for the wireless signal of the data frame 100 is determined based on two or more preambles 110 that are inserted into the data frame 100 and are a predetermined distance apart from each other. The receive sensitivity for the wireless signal of the data frame 100 may be an RSSI, SNR, BER, PER, SIR, or CIR.

In operation S640, the result of the determination performed in operation S630, i.e., the receive sensitivity for the wireless signal of the data frame 100, is transmitted to the MAC unit 440, and the MAC unit 440 generates a control frame 140 including the receive sensitivity for the wireless signal of the data frame 100. As described above, according to the present exemplary embodiment, the data frame 100 may include more than one preamble 110. In this case, the MAC unit 330 may generate a control frame for each of the preambles 110 included in the data frame 100.

In operation S650, the control frame 140 is transmitted to the second PHY unit 460, and the second PHY unit 460 transmits the control frame 140 to the transmitting station 300 via the second channel 102.

In operation S660, the transmitting station 300 adjusts a set of wireless parameters for the first channel 101 based on the control frame 140, and the receiving station 400 receive a data frame 1000 later according to the results of the adjustment performed by the transmitting station 300.

As described above, the apparatus for transmitting and receiving wireless data and the method of transmitting and receiving wireless data according to the present invention have the following advantages.

First, it is possible to smoothly transmit large amounts of data by transmitting a predetermined frame via one of a plurality of channels, receiving a response frame via another of the channels in return for the predetermined frame, determining the receive sensitivity for the predetermined frame based on the response frame, and controlling a set of TXVECTOR parameters according to the result of the determination.

Second, it is possible to establish a multi-channel environment by modifying a baseband layer and an RF layer while maintaining a conventional MAC layer and a conventional upper layer. Accordingly, it is possible to realize a communication system at low costs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for transmitting wireless data, the apparatus comprising:
a media access control (MAC) unit which generates a data frame;
a first physical (PHY) unit which transmits a wireless signal of the data frame via a first channel;
a second PHY unit which receives a control frame comprising a receive sensitivity for the wireless signal via a second channel; and
a parameter control unit which adjusts a set of TXVECTOR parameters for the data frame via the first channel based on the control frame.

2. The apparatus of claim 1, wherein the data frame comprises at least two preambles which are a distance apart from each other.

3. The apparatus of claim 2, wherein the second PHY unit receives a control frame for each of the at least two preambles.

4. The apparatus of claim 1, wherein the receive sensitivity comprises at least one of a received signal strength indicator (RSSI), a signal-to-noise ratio (SNR), a bit error rate (BER), a packet error rate (PER), a signal-to-interference ratio (SIR) and a carrier-to-interference ratio (CIR).

5. The apparatus of claim 1, wherein the first channel corresponds to a frequency band of 60 GHz, and the second channel corresponds to a frequency band of 2.4 or 5 GHz.

6. The apparatus of claim 1, wherein the first channel is a unidirectional channel having a directivity, and the second channel is a bidirectional channel having no directivity.

7. The apparatus of claim 1, wherein the TXVECTOR parameters comprise at least one of LENGTH, DATARATE, and TXPWR_LEVEL.

8. An apparatus for receiving wireless data, the apparatus comprising:
a first physical (PHY) unit which receives a data frame via a first channel and determines a receive sensitivity of the first channel based on the data frame;
a media access control (MAC) unit which generates a control frame comprising the receive sensitivity; and
a second PHY unit which transmits the control frame via a second channel.

9. The apparatus of claim 8, wherein the first PHY unit determines a receive sensitivity for each of at least two preambles that are inserted into the data frame and are a predetermined distance apart from each other.

10. The apparatus of claim 9, wherein the MAC unit generates a control frame for each of the at least two preambles.

11. The apparatus of claim 8, wherein the receive sensitivity comprises at least one of a received signal strength indicator (RSSI), a signal-to-noise ratio (SNR), a bit error rate (BER), a packet error rate (PER), a signal-to-interference ratio (SIR) and a carrier-to-interference ratio (CIR).

12. The apparatus of claim 8, wherein the first channel corresponds to a frequency band of 60 GHz, and the second channel corresponds to a frequency band of 2.4 or 5 GHz.

13. The apparatus of claim 8, wherein the first channel is a unidirectional channel having a directivity, and the second channel is a bidirectional channel having no directivity.

14. A method of transmitting wireless data, the method comprising:
generating a data frame;
transmitting a wireless signal of the data frame via a first channel;
receiving a control frame comprising a receive sensitivity for the wireless signal via a second channel; and
adjusting a set of TXVECTOR parameters for the data frame via the first channel based on the control frame.

15. The method of claim 14, wherein the data frame comprises at least two preambles which are a predetermined distance apart from each other.

16. The method of claim 15, wherein the receiving comprises receiving the control frame for each of the at least two preambles.

17. The method of claim 14, wherein the receive sensitivity comprises at least one of a received signal strength indicator (RSSI), a signal-to-noise ratio (SNR), a bit error rate (BER), a packet error rate (PER), a signal-to-interference ratio (SIR) and a carrier-to-interference ratio (CIR).

18. The method of claim 14, wherein the first channel corresponds to a frequency band of 60 GHz, and the second channel corresponds to a frequency band of 2.4 or 5 GHz.

19. The method of claim 14, wherein the first channel is a unidirectional channel having a directivity, and the second channel is a bidirectional channel having no directivity.

20. The method of claim 14, wherein the TXVECTOR parameters comprise at least one of LENGTH, DATARATE and TXPWR_LEVEL.

21. A method of receiving wireless data, the method comprising:
receiving a data frame via a first channel and determining a receive sensitivity of the first channel based on the data frame;
generating a control frame comprising the receive sensitivity; and
transmitting the control frame via a second channel.

22. The method of claim 21, wherein the determining the receive sensitivity comprises determining the receive sensitivity for each of at least two preambles that are inserted into the data frame and are a predetermined distance apart from each other.

23. The method of claim 22, wherein the generating comprises generating a control frame for each of the at least two preambles.

24. The method of claim 21, wherein the receive sensitivity comprises at least one of a received signal strength indicator (RSSI), a signal-to-noise ratio (SNR), a bit error rate (BER), a packet error rate (PER), a signal-to-interference ratio (SIR) and a carrier-to-interference ratio (CIR).

25. The method of claim 21, wherein the first channel corresponds to a frequency band of 60 GHz, and the second channel corresponds to a frequency band of 2.4 or 5 GHz.

26. The method of claim 21, wherein the first channel is a unidirectional channel having a directivity, and the second channel is a bidirectional channel having no directivity.
